(19) United States
(12) Patent Application Publication
(10) Pub. No.: US 2002/0021624 A1
(43) Pub. Date: Feb. 21, 2002

(54) Wrist watch

(76) Inventors: Haruki Hiranuma, Chiba-shi (JP); Koremoto Takeda, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 09/919,414

(22) Filed: Jul. 31, 2001

(30) Foreign Application Priority Data
Aug. 18, 2000 (JP) 2000-248745

(51) Int. Cl. G04B 37/00; G04B 39/00

(52) U.S. Cl. 368/282; 368/294

(57) ABSTRACT

To provide a wrist watch capable of easily exchanging a bezel by a user per se. A wrist watch is locked in a state in which a case body packing is arranged between a main body of an inner case bodyl including a module including an electronic circuit realizing watch function and an outer case body, an upper end face of a peripheral edge of an inner face body main body is pressed by an inner wall face of a decorative bezel main body and a spring projected portion is fitted to a click hole.

### BACKGROUND OF THE INVENTION

1. Field of the Invention

The present invention relates to a bezel attaching structure of a wrist watch and an assembled structure of a wrist watch, further particularly relates to a wrist watch providing a wrist watch having high design performance by making a bezel exchangeable easily by a user per se.

2. Description of the Prior Art

Generally, there is known a wrist watch in pursuit of design performance by attaching a decorative bezel at a surrounding of glass for protecting a dial. The bezel is formed in a doughnut shape in conformity with an outer shape of a wrist watch and is attached to a surface of the wrist watch. Further, it is general that the bezel serves also to function as a lid of a case main body containing a watch mechanism per se. In that case, a glass member is adhered or welded to a hole portion of the bezel in the doughnut shape, the bezel is attached to press to the case main body of the wrist watch to thereby hermetically close thereof by interposing a packing therebetween and the bezel cannot be removed unless special tool or special technology/technique is used. Meanwhile, a bezel attached by a so-to-speak rotational bezel structure, is rotatably attached to the case main body and the bezel is attached thereto such that the bezel is not removed unless special tool or special technology/technique is used similarly.

However, according to the above-described conventional wrist watch, the bezel cannot be removed unless special tool or special technology/technique is used and accordingly, the bezel cannot be exchanged easily and there poses a problem that a restriction in view of design is imposed in providing a wrist watch attached with a bezel to suit to taste of a user.

### SUMMARY OF THE INVENTION

Hence, the invention has been carried out in view of the (above-described and it is an object thereof to provide a wrist watch enlarging a degree of freedom of design of a wrist watch attached with a bezel to suit to taste of a user and capable of exchanging the bezel easily by a user per se who does not use special tool or special technology/technique.

In order to achieve the above-described object, the invention characterized in that a screwing structure including a bayonet structure is constituted by a bezel of a wrist watch and a main body excluding the bezel and comprises a projected portion having a front end in a semispherical shape or in a shape of a mountain provided on one side of the bezel and an opposed face of the main body and urged to other side by an elastic member and a recess portion provided on the other side and fitted with the front end of the projected portion. Further, the bezel may be attached with a bayonet part comprising an elastic member integrally formed with the projected portion on a side of the opposed face of the main body and the main body may include the recess portion on the side of the opposed face of the bezel. Further, the recess portion may be formed by being surrounded by the projected portion projected to a face of forming thereof.

Further, the invention is characterized in a wrist watch comprising an inner case body including a watch function part, an outer case body forming a containing portion in conformity with an outer shape of the inner case body and attached with a strap made to wrap on the arm, and a bezel for fixing the inner case body to the outer case body, wherein the wrist watch is assembled by sandwiching the inner case body between the outer case body and the bezel.

### BRIEF DESCRIPTION OF THE SEVERAL VIEWS OF THE DRAWINGS

A preferred form of the present invention is illustrated in the accompanying drawings in which:

FIG. 1 is a side view of a wrist watch according to an embodiment of the invention;

FIG. 2 is a disassembled side view showing an assembled structure of the wrist watch according to the embodiment of the invention;

FIGS. 3A-3C are explanatory views of an outer case body constituting the wrist watch according to the embodiment of the invention;

FIG. 4 is a sectional view taken along a line A-a shown in FIG. 3;

FIG. 5 is a partially cut side view of an inner case body constituting the wrist watch according to the embodiment of the invention;

FIGS. 6A and 6B explanatory views of a bezel constituting the wrist watch according to the embodiment of the invention;

FIGS. 7A-7C are explanatory views of a bayonet part of the outer case body constituting the wrist watch according to the embodiment of the invention;

FIG. 8 is a sectional view taken along a line B-b shown in FIGS. 7;

FIGS. 9A and 9B illustrate sectional views taken along a line C-c and a view viewing in an arrow mark D direction shown in FIGS. 7;

FIG. 10 is an assembled sectional view showing an assemble structure of the wrist watch according to the embodiment of the invention;

FIG. 11 is a sectional view showing other example 1 of a bezel attaching structure of a wrist watch according to an embodiment of the invention;

FIG. 12 is a sectional view showing other example 2 of a bezel attaching structure of a wrist watch according to an embodiment of the invention;

FIG. 13 is a sectional view showing other example 3 of a bezel attaching structure of a wrist watch according to an embodiment of the invention; and

FIG. 14 is a sectional view showing other example 4 of a bezel attaching structure of a wrist watch according to an embodiment of the invention.

### DETAILED DESCRIPTION OF THE PREFERRED EMBODIMENTS

A detailed explanation will be given of the invention in reference to the drawings as follows. Further, the invention is not limited by embodiments thereof.

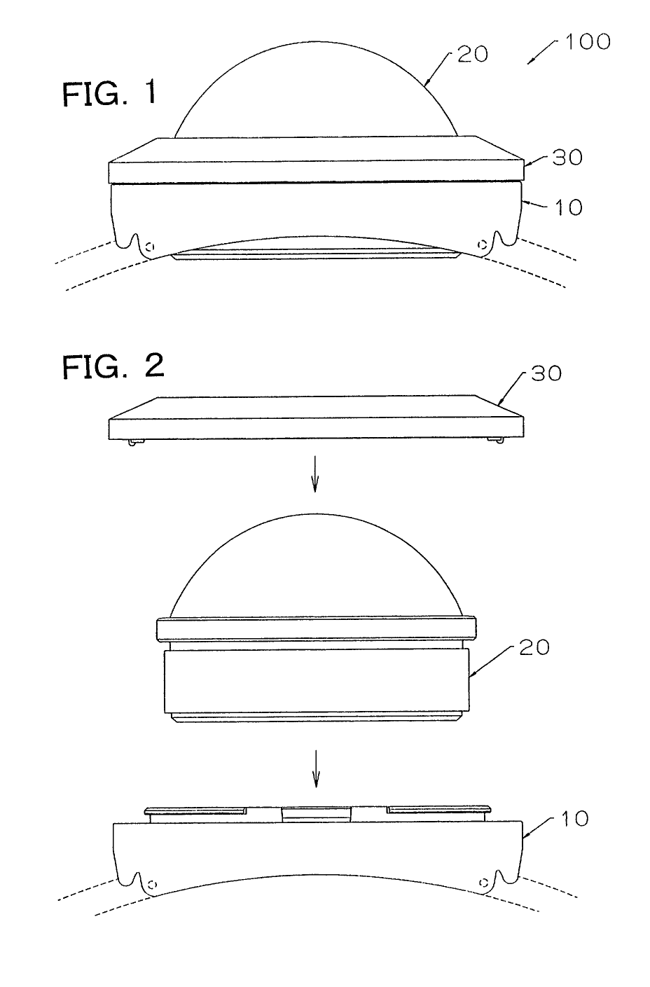

FIG. 1 is a side of view of a wrist watch according to an embodiment of the invention. FIG. 2 is a disassembled side view showing an assembled structure of the wrist watch according to the embodiment of the invention. As shown by FIG. 1 and FIG. 2, the wrist watch 100 is constituted by an outer case body 10 attached with a strap shown by broken lines, an inner case body 20 attached to the outer case body 10 and a bezel 30 fixing the inner case body 20 to the outer case body 10 and subjected to a design and is of a structure assembled by fitting the inner case body 20 to the outer case body 10 and screwing the bezel 30 to the outer case body 10 such that the inner case body 20 is fixed to the outer case body 10. An explanation will successively be given of the outer case body 10, the inner case body 20 and the bezel 30 constituting the wrist watch 100.

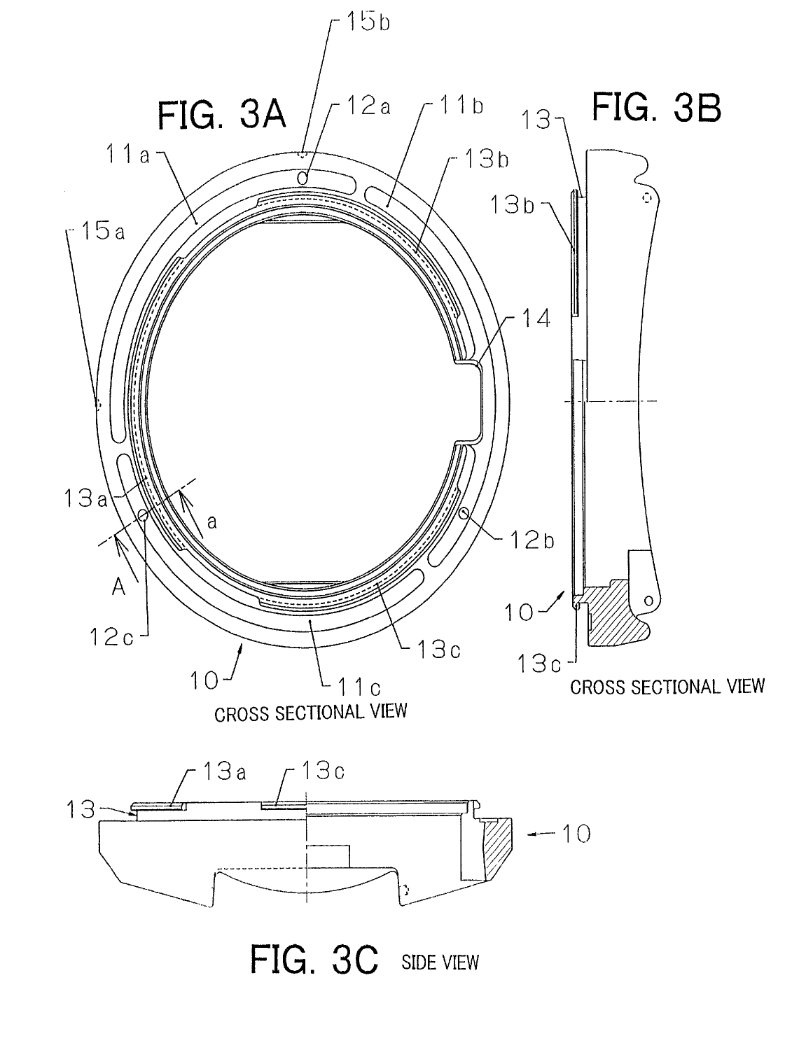

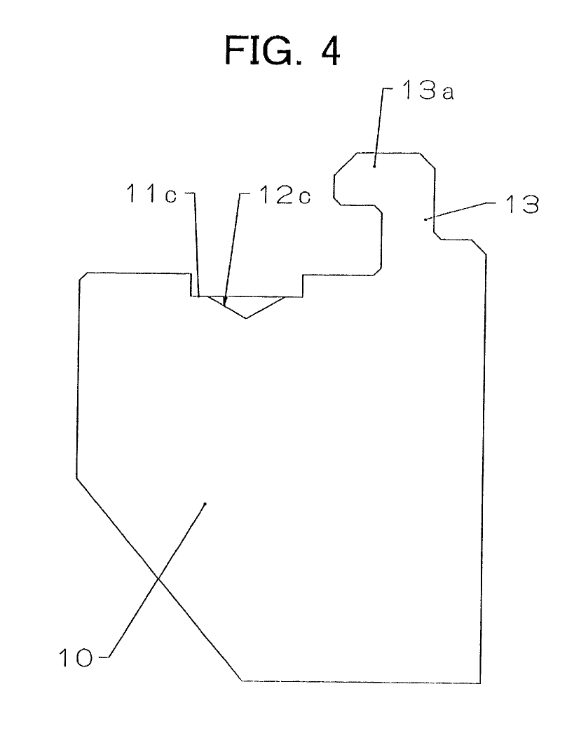

FIGS. 3 are explanatory views of the outer case body constituting the wrist watch according to the embodiment of the invention. FIG. 4 is a sectional view taken along a line A-a shown in FIG. 3. Further, FIG. 3A shows a top plane view, FIG. 3B shows a partially cut side view and FIG. 3C shows a partially cut side view. As shown by FIG. 3, the outer case body 10 is formed in a doughnut shape and provided with grooves 11a, 11b and 11c in a fan-like shape on a top side (watch surface side) at intervals to divide a circumference equally into three portions.

Further, as shown in FIG. 4 (FIGS. 3), the groove 11c is provided with a click hole 12c having a section in a shape of a wedge. The top side (watch surface side) of the outer case body 10 is projected with a fitting portion 13 in a shape of a circular cylinder formed with a projected edge portion 13a. Similarly, as shown by FIGS. 3, the grooves 11a and 11b are also provided with click holes 12a and 12b. Further, the top side (watch surface side) of the outer case body 10 is projected with the fitting portion 13 in the shape of the circular cylinder formed with projected edge portions 13a and 13b. Further, an inner wall of a hole portion of the outer case body 10 is provided with a notched portion (hereinafter, abbreviated as ‘notch portion’) 14. Further, a peripheral edge of the outer case body 10 is provided with positioning holes 15a and 15b. The positioning hole 15a is a positioning hole in detaching and fitting the bezel 30. The positioning hole 15b constitutes a lock position of the bezel 30.

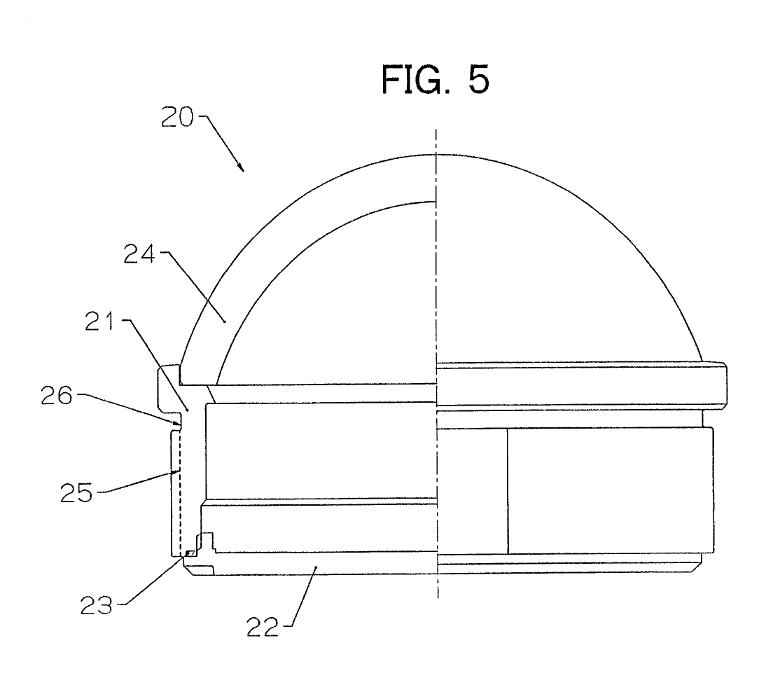

FIG. 5 is a partially cut side view of the inner case body constituting the wrist watch according to the embodiment of the invention. The inner case body 20 includes a movement of an analog watch or a module of a digital watch, not illustrated, in a hermetically closed state and is provided with an inner case body main body 21 in a shape of a circular cylinder, a case back 22 attached to a bottom end side (back side of watch of the inner case body main body 21, a case back packing 23 for ensuring water tightness between the case back 22 and the inner case back main body 21, a glass member 24 in a semispherical shape attached to a top end side (watch top side) of the inner case body main body 21, a positioning projection 25 provided at a peripheral edge of the inner case body main body 21 and a case body packing biting groove 26.

Further, although in this case, there is shown a case in which connection between the glass member 24 and the inner case body main body 22 is carried out by adherence, the connection is not limited thereto but, for example, the connection may be carried out by plastic bonding for fixing the glass member 24 to the inner case body maine body 21 by sandwiching a packing of plastic therebetween or welding. Further, although in this case, there is shown a case in which connection between the case back 22 and the inner case back main body 21 is carried out by a screw fit structure via the case back packing 23, the connection is not limited thereto but, for example, the connection may be carried out by a structure of biting or fastening by small screws.

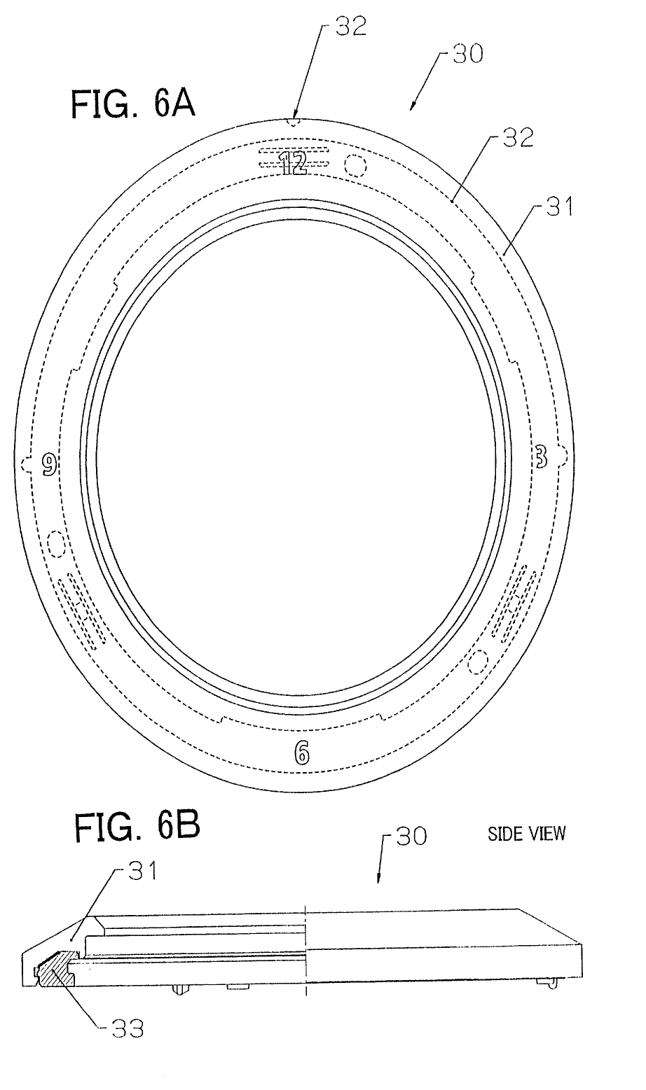

FIGS. 6 are explanatory views of the bezel constituting the wrist watch according to the embodiment of the invention. The bezel 30 is provided with a decorative bezel main body 31 formed in a doughnut shape and decorated on a top side (watch top side) thereof, a mark hole 32 provided at an outer periphery of the decorative bezel main body 31 arid a bayonet part 33 in a doughnut shape attached along an inner wall on a rear face side of the decorative bezel main body 31. Hereinafter, further, an explanation will be given of the bayonet part 33.

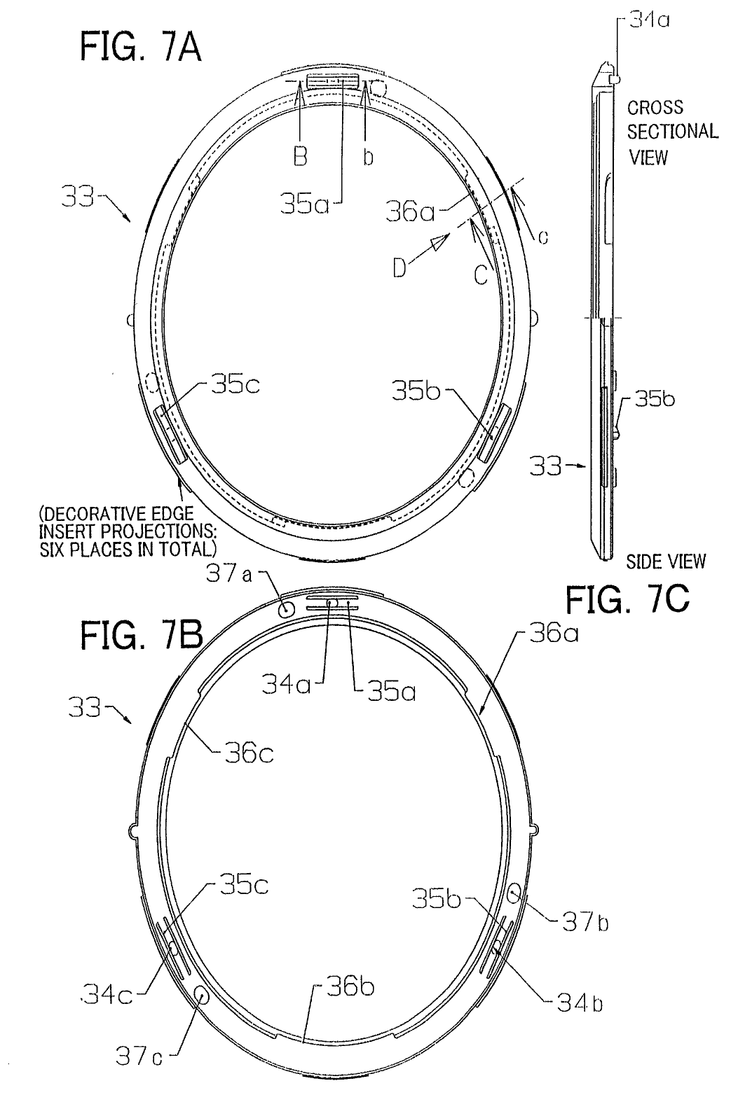

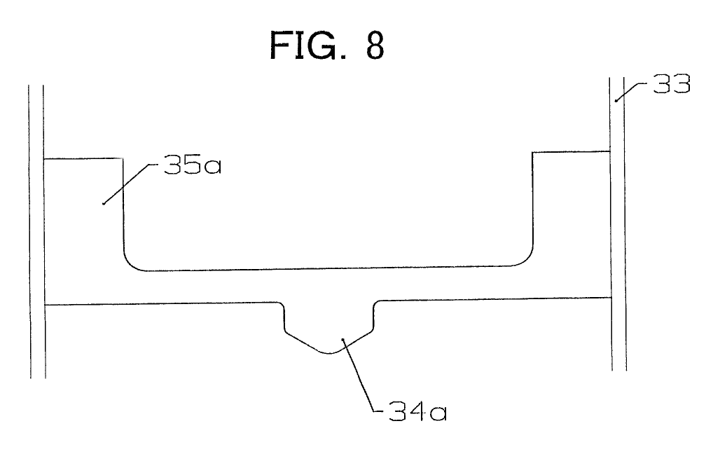

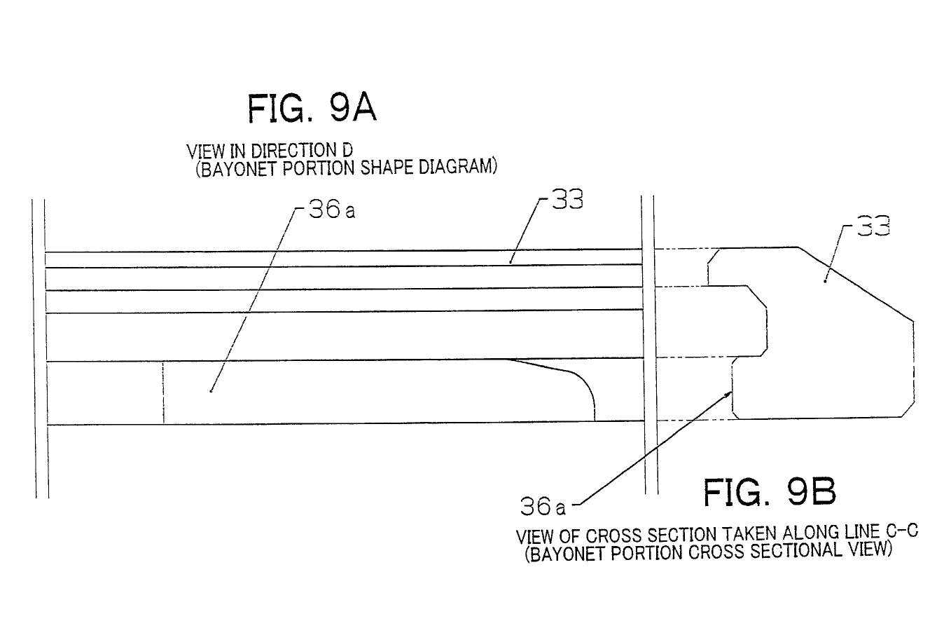

FIGS. 7 are explanatory views of the bayonet part of the outer case body constituting the wrist watch according to the embodiment of the invention. FIG. 8 is a sectional view taken along a line B-b shown in FIGS. 7. FIGS. 9 illustrate sectional views taken along C-c and a view viewing in an arrow mark D direction shown in FIGS. 7. Further, FIG. 7A shows a top plane view, FIG. 7B shows a bottom plane view and FIG. 7C shows a partially cut side view. As shown by FIG. 8 (FIGS. 7), the bayonet part 33 is integrally formed with a spring member 35a provided with a spring projected portion 34a directed to a bottom plane side (watch bottom side) thereof. Similarly, as shown by FIGS. 7., the bayonet member 33 is integrally formed with spring members 35b and 35c provided with spring projected portions 34b and 34c directed to bottom plane sides (watch bottoms sides) thereof.

Further, as shown by FIGS. 9 (FIGS. 7), the bayonet part 33 is integrally formed with a bayonet portion 36a projected to an inner wall face side thereof. When the bezel 20 is fitted to the outer case body 10 and detached therefrom, the bayonet portion 36a is disposed between the projected edge portions 13c and 13a and in locking, the bayonet portion 36a is caught by the projected edge portion 13a to thereby operate such that the bezel 20 is prevented from being detached from the outer case body 10. Similarly, as shown by FIGS. 7, the bayonet part 33 is integrally formed with bayonet portions 36b and 36c projected to inner wall face sides thereof. When the bezel 20 is fitted to the outer case body 10 and detached therefrom, the bayonet portions 36b and 36c are disposed respectively between the projected edge portions 13a and 13b and between the projected edge portions 13b and 13c and in locking, the bayonet portions 36b and 36c are caught respectively by the projected edge portions 13b and 13c to thereby operate such that the bezel 20 is prevented from being detached from the outer case body 10.

Further, as shown by FIGS. 7, the bayonet part 33 is integrally formed with stoppers 37a, 37b and 37c directed to bottom plane sides (watch bottom sides) thereof. The stoppers 37a, 37b and 37c are respectively fitted to the click holes 12a, 12b and 12c of the outer case back 10. Further, although as a material of the bayonet part 33, POM (polyoxyniethylene is preferable in view of elasticity and durability, ABS (acrynitrile-butadiene-styrene resin) or PC (polycarbonate) may be used therefor.

Next, an explanation will be given of an assembly procedure when the watch is assembled such that the inner case back 20 is fitted to the outer case back 10 and the inner case back 20 is fixed to the outer case back 10 as shown by FIG. 2. First, the bezel 30 is made to overlap the outer case body 10 such that the bayonet portions 36a, 36b and 36c (refer to FIGS. 7), are fitted respectively among the projected edge portions 13a, 13b and 13c (refer to FIGS. 3) Next, in the case of viewing from the top plane side shown in FIG. 3A, when the bezel 30 is rotated in the clockwise direction, the bayonet portions 36a, 36b and 36c (refer to FIGS. 7) enter lower sides of the projected edge portions 13a, 13b and 13c (refer to FIGS. 3).

Simultaneously therewith, the spring projected portion 34c (refer to FIGS. 7) is slidingly moved above the groove 11c. At this occasion, the spring member 35c (refer to FIGS. 7) is pressed by the groove 11c and is brought into a state of being urged to the top side (watch top side). Further, when the bezel 30 is rotated further in the clockwise direction, the spring projected portion 34c is fitted to and locked by the click hole 12c by elastic force. In this way, by fitting the spring projected portion 34c to the click hole 12c by the elastic force, a user is provided with click feeling and can recognize that the bezel 30 is attached to a predetermined position.

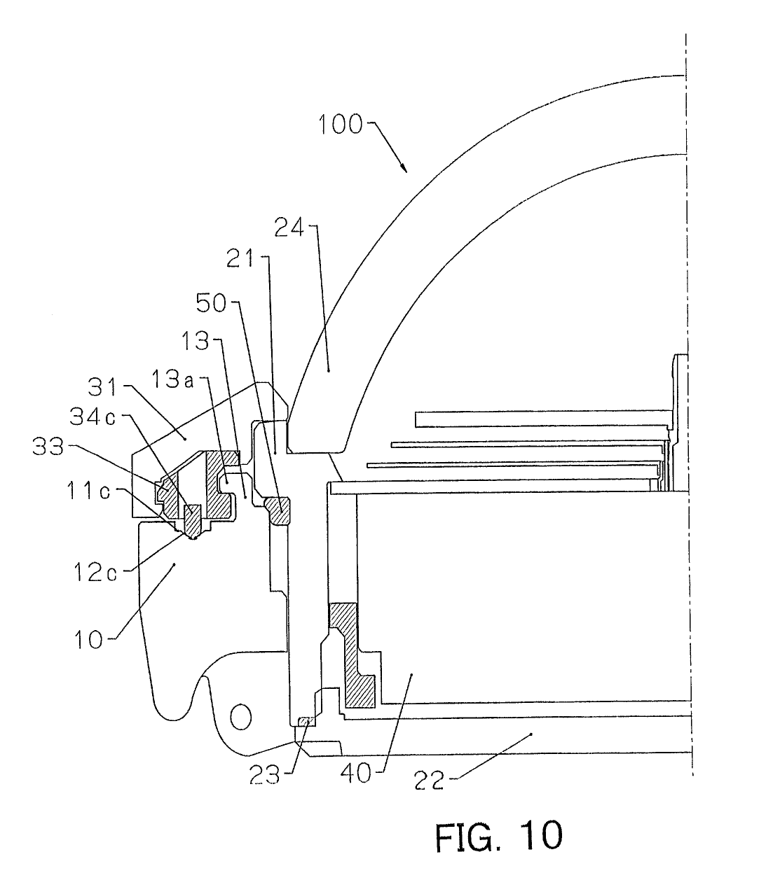

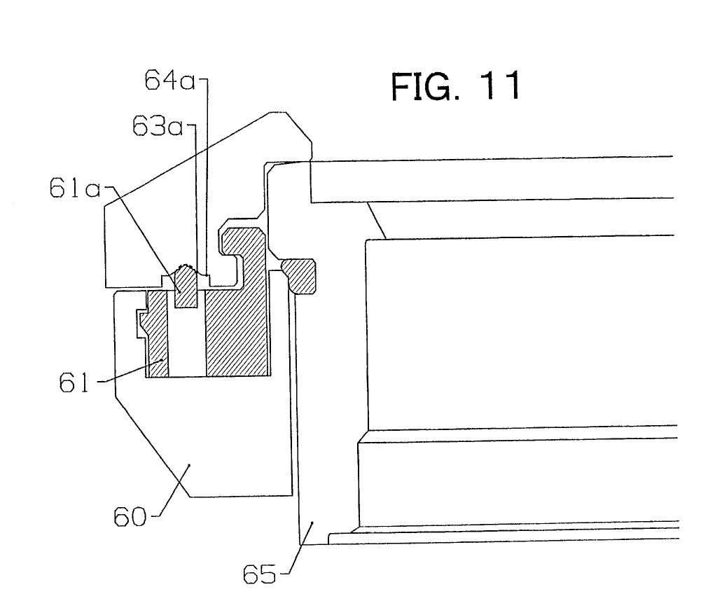

Next, an explanation will be given of the structure of a wrist watch 100 when assembled as described above. FIG. 10 is a assembled sectional view showing as assembled structure of the wrist watch according to the embodiment of the invention. As shown by FIG. 10, the wrist watch 100 is constituted by the structure in which a case body packing 50 is arranged between the main body of the inner case body 21 including a module 40 including an electronic circuit realizing watch function and the outer case body 10 and the wrist watch 100 is locked in a state in which an upper end face of a peripheral edge of the inner case body main body 21 is pressed by an inner wall face of the decorative bezel main body 31 and the spring projected portion 34c is fitted to the click hole 12c. Further, the glass member 24 is projected from the hole portion of the bezel 30, further, the case back 22 is disposed on the bottom face side of the outer case body 10.

Further, although according to the embodiment, an explanation has been given of the bezel attaching structure for locking the bezel 30 to the outer case body 10 by fitting the spring projected portion 34c to the click hole 12c, an explanation will be given of other examples 1 through 4 as follows. Further, there may be constituted any structure so far as the structure is provided with similar operation other than the above-described bezel attaching structure and the other examples 1 through 4, mentioned later.

FIG. 11 is a sectional view showing other example 1 of a bezel attaching structure of a wrist watch according to an embodiment of the invention. The wrist watch of other example 1 is constituted by a structure in which a bayonet part 61 is attached to a side of an outer case body 60. That is, there is constructed a structure in which the bayonet part 61 is integrally formed with a spring projected portion 61a in correspondence with the spring projected portion 34a, further, a side of a bezel 62 is formed with a groove 63a in correspondence with the groove 11a and provided with a click hole 64a in correspondence with the click hole 12a. Further, an inner case body 65 is constituted to be similar to the inner case back 20. However, a glass member and a case back are omitted in the drawing.

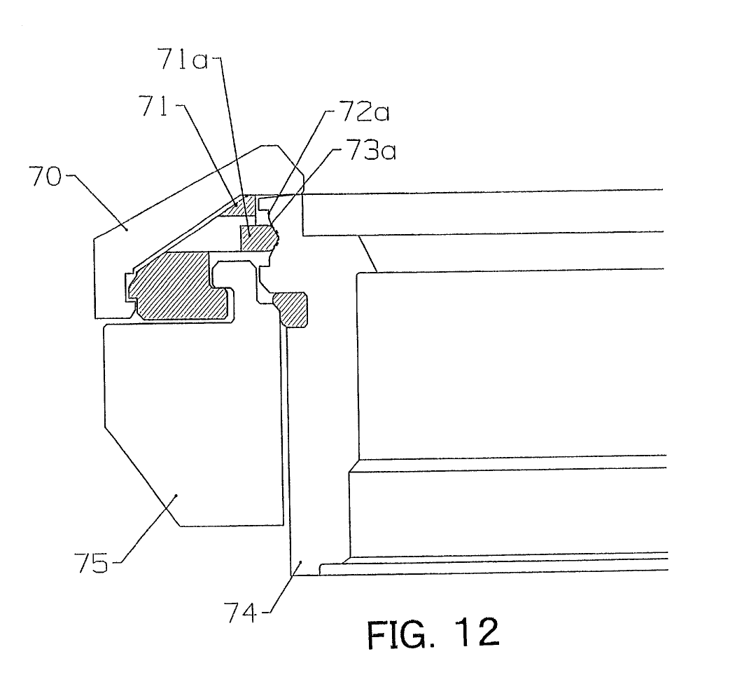

FIG. 12 is a sectional view showing other example 2 of a bezel attaching structure of a wrist watch according to an embodiment of the invention. The wrist watch of other example 2 is constituted by a structure in which a bayonet part 71 is attached to a side of a bezel 70 and a groove 72a and a click hole 73a are provided to an inner case body 74. That is, there is constituted a structure in which the bayonet part 71 is integrally formed with a spring projected portion 71a in correspondence with the spring projected portion 34a, further, a peripheral edge of an inner case body 74 is formed with the groove 72a in correspondence with the groove 11a and is provided with the click hole 73a in correspondence with the click hole 12a. Further, an outer case body 75 differs from the above-described in that there are not provided the inner case body 10 and the click hole. Further, in the drawing a glass member and a case back of the inner case body 74 are omitted.

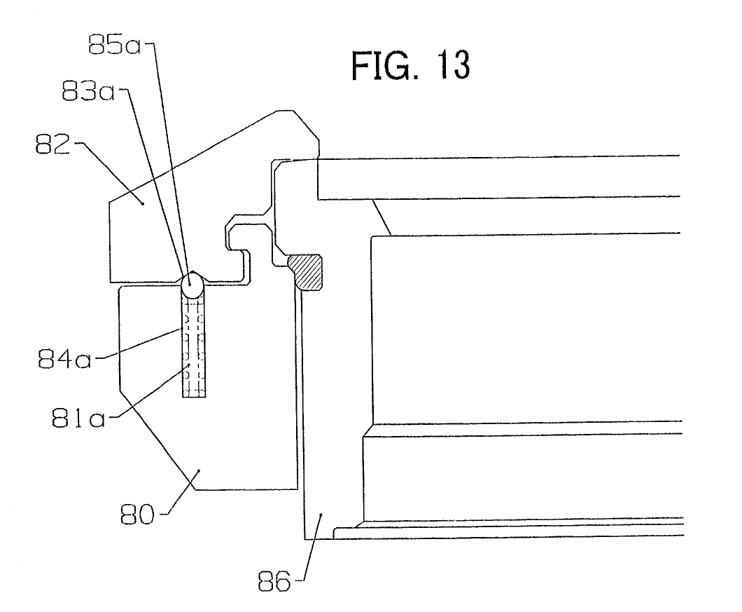

FIG. 13 is a sectional view showing other example 3 of a bezel attaching structure of a wrist watch according to an embodiment of the invention. The wrist watch of other example 3 is constituted by a structure in which a helical spring member 81a is attached to a side of an outer case body 80 and the wrist watch is locked by a click hole 83a provided on a side of a bezel 82. Further, the helical spring member 81a is inserted into a hole 84a provided in the outer case body 80 and a projected front end thereof is attached with a spherical member 85a. Further, in the drawing, a glass member and a case back of an inner case body 86 are omitted.

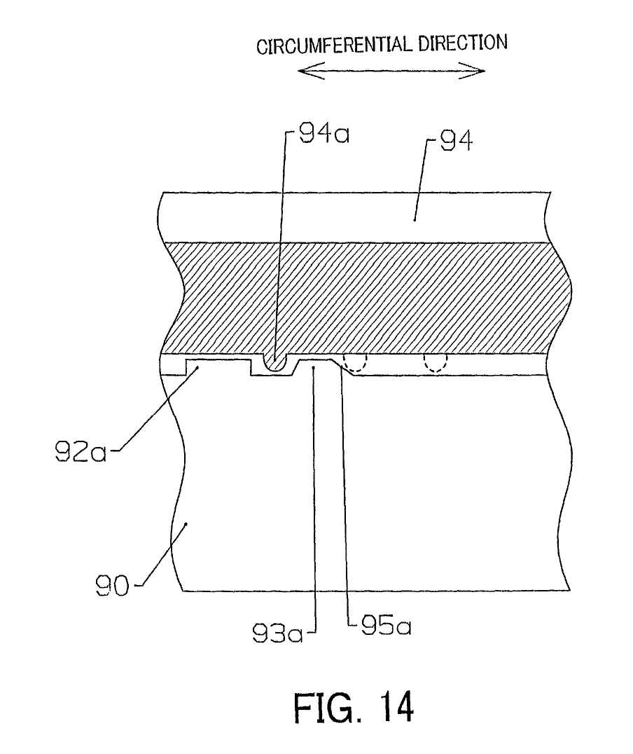

FIG. 14 is a sectional view showing other example 4 of a bezel attaching structure of a wrist watch according to an embodiment of the invention. The wrist watch of other example 4 is constituted by a structure in which in place of the click hole 12c, stopper projections 92a and 93a are provided at an outer case body 90 and a spring projected portion 94a of a bayonet portion 94 attached to a bezel 94, is dammed between the stopper projections 92a and 93a. Further, the stopper projection 93a is formed with a tapper face 95a such that when the bezel 94 is attached to the outer case body 90, the bezel 94 is easy to rotate in a direction of rotating thereof.

Further, although according to the above-described embodiment, an explanation has been of a case of providing the grooves 11a, 11b and 11c at the outer case body 10, it is not necessarily needed to provide the grooves 11a, 11b and 11c. Further, although an explanation has been given of a case of providing the three grooves 11a, 11b and 11c, a number of the grooves is not limited there to but may be any number. Similarly, numbers of the click holes 12a, 12b and 12c and the spring projected portions 35a, 35b and 35c are not limited thereto but may be any numbers. Further, although according to embodiment, the shape of the glass member 24 of the inner case body 20 is made the semispherical shape, the shape is not limited thereto but may be a shape of a flat plate.

Further, materials of the outer case body 10, the inner case body 20 (except the glass member) and the decorative bezel main body 31 may be either of metal and resin. Further, although the bezel attaching structure of the wrist watch according to embodiment is a structure in which the bezel 30 is attached to the outer case body 10 and the inner case body 20, even when the bezel is directly attached to a case main body of a conventional wrist watch, a similar structure can be constituted. Further, the screw structure of fixedly attaching to screw the bezel 30 to the outer case body 10, is not limited to that of the case of the above-described embodiment but, for example, there may be constituted a structure of two streaks screw.

According to the above-described embodiment, there is constituted the structure in which the bayonet part is constituted by the elastic member and the spring projected portion formed at the bayonet part slidingly moves above the outer case body and therefore, the outer case body is difficult to be impaired, further, wear of surface treatment is reduced. Further, positioning is facilitated by the spring projected portion and the click hole. For example, the positioning is facilitated by also attaching a pattern with regard to the position such as graduations at the bezel. Therefore, design performance is promoted and operation of exchange by a user is facilitated. Further, the spring projected portion is fitted to the click hole by the elastic force and accordingly, slacking by impact is difficult to occur and chances of detachment in carrying thereof can be reduced.

Therefore, according to the embodiment, by exchanging the inner case body, the wrist watch main body (inner case body) having a different function can be attached to a bezel or a strap (outer case body) having preferred design. For example, a watch main body (inner case body) in analog specification can be used by being exchanged by a watch main body (inner case body) in digital specification. Further, since the bezel can easily be exchanged, a wrist watch having a design suited to taste of a user is easy to provide by abundantly preparing designs of bezels. Further, a user can use a wrist watch having different design or function in conformity with TPO or in accordance with mood of day and a wrist watch suited to taste of a user can easily be provided.

As has been explained, according to the bezel attaching structure of the wrist watch of the invention, the bezel can easily be exchanged and accordingly, there is achieved an effect of easily providing a wrist watch having a design suited to taste of a user by abundantly preparing designs of bezels. Further, a user can use a wrist watch having different design in conformity with TPO or in accordance with mood of day and there is achieved an effect capable of easily providing a wrist watch suited to taste of a user.

Further, according to the assembled structure of the wrist watch of the invention, there is achieved and effect capable of attaching a wrist watch main body (inner case body) having different function to a bezel or a strap (outer case body) having preferred design. For example, a watch main body (inner case body) in analog specification can be used by being exchanged by a watch main body inner case body) in digital specification.

What is claimed is

1. A wrist watch comprising:
a main body;
a bezel;
wherein the main body and the bezel are constituted by a screwing structure including a bayonet structure,
the bayonet structure is provided a projected portion having a front end in a semispherical shape or in a shape of a mountain provided on one side of the bezel and an opposed face of the main body and urged to other side by an elastic member, and a recess portion provided on the other side and fitted with the front end of the projected portion.

2. A wrist watch according to claim 1, wherein the bezel is attached with a bayonet part comprising an elastic member integrally formed with the projected portion on a side of the opposed face of the main body and the main body includes the recess portion on the side of the opposed face of the bezel.

3. A wrist watch according to claim 1, wherein the recess portion is formed by being surrounded by the projected portion projected to a face of forming thereof.

4. A wrist watch characterized in comprising:
an inner case body including a watch function part,
an outer case body forming a containing portion in conformity with an outer shape of the inner case body and attached with a strap made to wrap on the arm; and
a bezel for fixing the inner case body to the outer case body;
wherein the wrist watch is assembled by sandwiching the inner case body between the outer case body and the bezel.
